(19) United States
(12) Patent Application Publication
(10) Pub. No.: US 2007/0262732 A1
(43) Pub. Date: Nov. 15, 2007

(54) Method for controlling LED-based backlight module

(75) Inventor: Yuh-Ren Shen, Hsinchu (TW)

Correspondence Address: BIRCH STEWART KOLASCH & BIRCH, PO BOX 747, FALLS CHURCH, VA, 22040-0747, US

(73) Assignee: Vastview Technology Inc.

(21) Appl. No.: 11/430,937

(22) Filed: May 10, 2006

(51) Int. Cl. H05B 39/00

(52) U.S. Cl. 315/312

(57) ABSTRACT

The method of the present invention turns off the line of LEDs of a backlight module behind the currently enabled scanline of a LCD device so that the transient behavior of the liquid crystal molecules are less obvious, thereby enhancing the dynamic response of the LCD device. For one type of embodiments, in accordance with the top-down scanning of the LCD device, the corresponding horizontal lines of the LEDs of the backlight module are turned off in a certain manner so that they exhibit a lighting (or, more precisely, darkening) pattern as if they are also “scanned” from top to down. For another type of embodiments, the horizontal lines of the LEDs of the backlight module are turned off and on simultaneously so that the backlight module actually “flashes” the LCD device.

### BACKGROUND OF THE INVENTION

1. Field of the Invention

The present invention generally relates to backlight modules for display devices, and more particularly to a method for controlling the light emitting diodes of a direct-lit backlight module.

2. The Prior Arts

Currently, most backlight modules for large-sized liquid crystal displays (LCDs) or LCD TVs adopt either cold cathode fluorescent lamps (CCFLs) or light emitting diodes (LEDs) as light source. As the CCFLs suffer potential environmental issues from the mercury vapor contained in the lamp tubes, while the LEDs have been advanced to provide superior switching speed, lighting efficiency, and cost, LEDs have become the main stream light source for LCDs. FIG. 7 is a schematic diagram showing a conventional LED-based, direct-lit backlight module. As illustrated, multiple LEDs are arranged in an array in front of a reflection plate. These LEDs could be white-light LEDs, or red-, green-, or blue-light LEDs in various combinations. Usually, there are diffusion sheets and prism sheets in front of the LEDs for enhancing the uniformity and brightness of light projected to the LCD panel.

It is well known that LCDs are hold-type display device due to the retardation property of the liquid crystal molecules. Compared to the impulse-type display devices such as cathode ray tube (CRT) displays, the dynamic response (i.e., the display quality of dynamic images) of the LCDs has been notoriously inferior. This defect of LCDs therefore has been the major research and development focus both throughout academic and industrial arenas, and various techniques for improving the retardation of the LCDs have been disclosed.

On the other hand, the development of the backlight modules mainly focuses on how to enhance the uniformity and brightness of the light provided by the backlight module. But recently, as the LED-based, direct lit solution has become the main steam technology for backlight modules, there are interests in utilizing the fast switching speed of the backlight LEDs to improve the LCD's dynamic response.

### SUMMARY OF THE INVENTION

Therefore, the major objective of the present invention is to control the lines of LEDs of a direct-lit backlight module within a frame time so as to achieve an impulse-type display effect from a hold-type LCD device due to the retardation properties of the liquid crystal molecules and, in the mean time, to lessen the blur or flicker problem of the LCD device. The method provided by the present invention is implemented in a driver controller of the LED-based, direct-lit backlight module.

To achieve the objective, the present invention mainly tries to solve the issue that, when a scanline of the pixels of the LCD device is enabled (i.e., scanned), the grey levels of the pixels have to undergo a transient period before they reach their targeted level. The method of the present invention turns off the line of LEDs behind the currently enabled scanline so that the transient behavior of the liquid crystal molecules are less obvious, thereby enhancing the dynamic response of the LCD device. There are various embodiments of the present invention. For one type of embodiments, in accordance with the top-down scanning of the LCD device, the corresponding horizontal lines of the LEDs of the backlight module are turned off in a certain manner so that they exhibit a lighting (or, more precisely, darkening) pattern as if they are also “scanned” from top to down. For another type of embodiments, the horizontal lines of the LEDs of the backlight module are turned off and on simultaneously so that the backlight module actually “flashes” the LCD device.

However, when a line of LEDs are turned off when its corresponding scanline is enabled, the light from the neighboring lines of LEDs will permeate to the coverage area of the turned-off line, thereby discounting the effectiveness of the present invention. To overcome this problem, scanning-like embodiments can be augmented by various adjustments so as to reduce the brightness and, therefore, the amount of light leakage, of the neighboring lines of LEDs.

A type of these adjustments is to gradually increase the brightness of an originally darkened line of LEDs when it is tuned from the darkened state to full brightness so that its impact on the adjacent newly darkened lines of LEDs is diminished. Similarly, another type of these adjustments is to gradually decrease the brightness of an originally lighted line of LEDs when it is tuned from the lighted state to full darkness so that its impact on the adjacent originally darkened lines of LEDs is diminished.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIGS. 1a and 1b are two exemplary configurations of the drivers and driver controller of a direct-lit backlight module.

FIGS. 2a, 2b, and 2c are driver control signal waveform diagrams showing various variations of a first embodiment of the present invention.

FIGS. 3a, 3b, 3c, 3d, and 3e are driver control signal waveform diagrams showing various variations of a second embodiment of the present invention.

FIGS. 4a, 4b, 4c, and 4d are driver control signal waveform diagrams showing various variations of a third embodiment of the present invention.

FIGS. 5a, 5b, and 5c are driver control signal waveform diagrams showing various variations of a fourth embodiment of the present invention.

FIGS. 6a, 6b, and 6c are driver control signal waveform diagrams showing various variations of a fifth embodiment of the present invention.

FIG. 7 is a schematic diagram showing a conventional LED-based, direct-lit backlight module.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

The method provided by the present invention is implemented in a driver controller of a direct-lit backlight module using multiple LEDs as light source. Please note that the backlight module can be applied to LCDs, plasma displays, and organic light emitting displays (OLEDs). However, for simplicity, the following description mainly uses a LCD device as example.

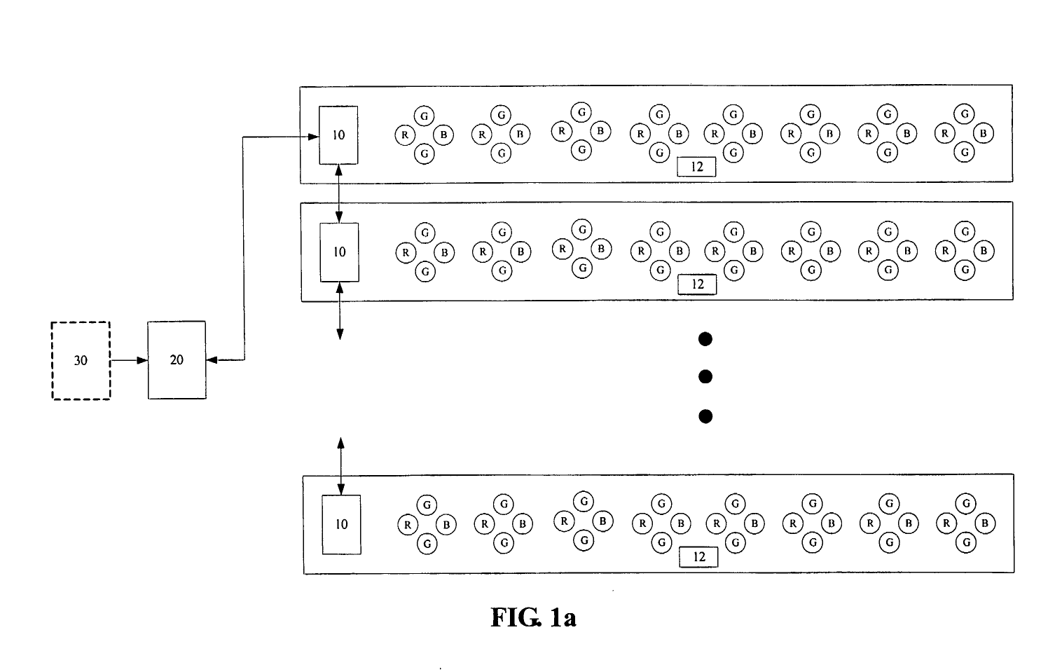

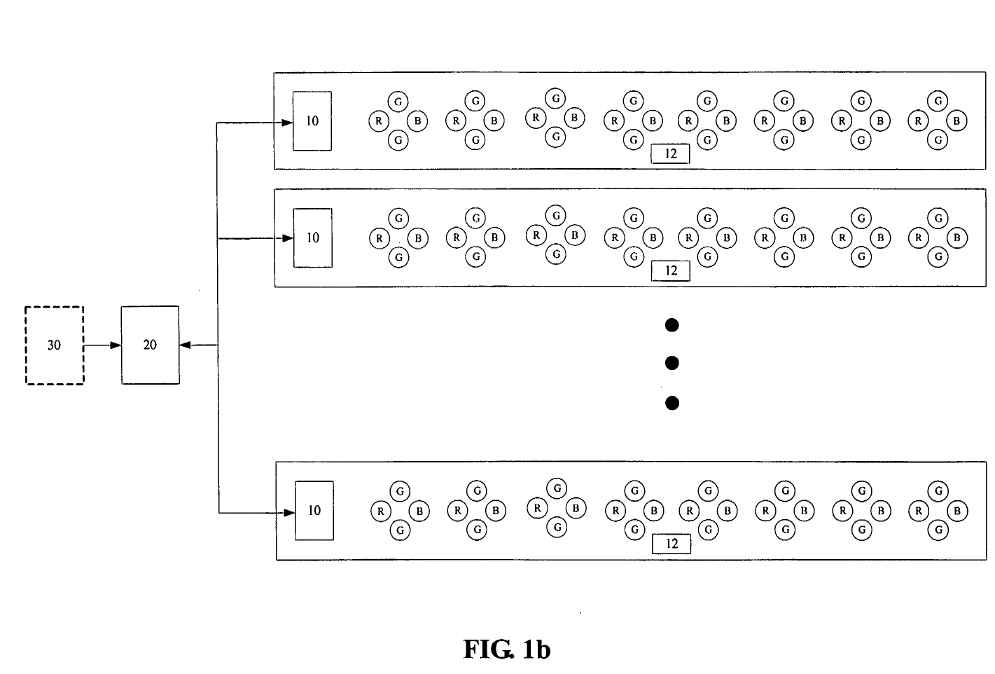

The driver controller embodying the present invention connects and controls multiple drivers of the direct-lit backlight module, each of which in turn drives a portion of the LEDs (i.e., control their on/off and brightness). FIGS. 1a and 1b are two exemplary configurations of the drivers and driver controller of a direct-lit backlight module. As illustrated, every driver 10 drives a number of sets of LEDs arranged in a horizontal line. Each set of LEDs contains a red-light (R) LED, a blue-light (B) LED, and two green-light (G) LEDs, and all red-light LEDs, blue-light LEDs, and green-light LEDs in a line are in separate series connection to the driver 10 respectively. For simplicity, the connection circuits are not provided in the drawing. On the other hand, the driver controller 20 receives various timing signals such as Vsync, DE, DCLK from the timing controller 30 of the LCD device, and then, via the series-connection configuration shown in FIG. 1a or the parallel-connection configuration shown in FIG. 1b, provides control signals to the drivers 10 stage by stage (if they are connected as in FIG. 1a) or simultaneously (if they are connected in FIG. 1b). As also shown in the drawings, sensors 12 are provided at appropriate locations within each line of the sets of LEDs for detecting temperature or color and feeding the information back to the drivers 10 for adjusting their drives to the LEDs.

Please note that what is displayed in FIGS. 1a and 1b is only exemplary; the combinations of the various colored LEDs and their connections to the drivers 10 are not intended to constraint the present invention, but to facilitate the explanation of the present invention. Basically, the present invention is applicable to any LED-based, direct-lit backlight modules that: (1) have a number of LEDs arranged in a number of horizontal lines; (2) have a number of drivers each driving at least a line of LEDs; (3) have at least a driver controller controlling the drivers based on the timing signals of the LCD device. It has to be stressed again that the connection between the driver controller 20 and the drivers 10 is not limited to series connection or parallel connection. A combination of series and parallel connections or other manners of connections can be adopted as well. Furthermore, the driver controller 20 can also simultaneously control the drivers 10 via series connection; or the driver controller 20 can also control the drivers 10 in sequence via parallel connection.

The backlight module's having the LEDs arranged in lines and having the drivers 10 to turn on/off the lines of LEDs is in accordance with the scanning operation of the LCD device (please note that, however, the number of lines of LEDs may not be identical to the number of scanlines of the LCD device). The major characteristic of the present invention lies in how to control the on/off of the n lines of LEDs of the backlight module so as to make the transient behavior of the scanlines of the LCD device less obvious and, in the mean time, lessen the blur and flicker phenomenon of a typical LCD device.

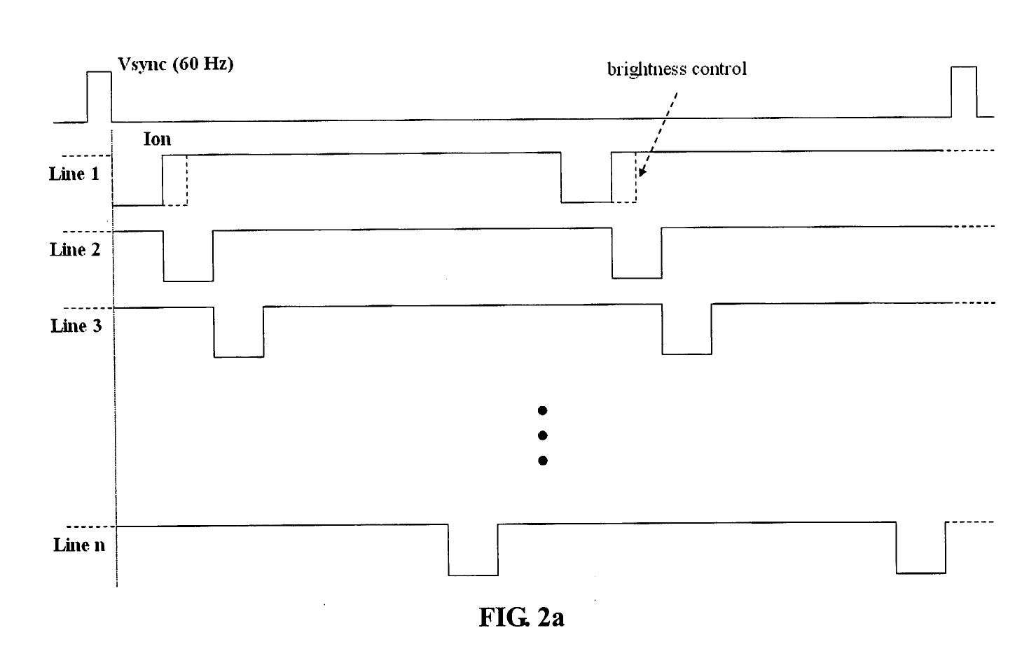

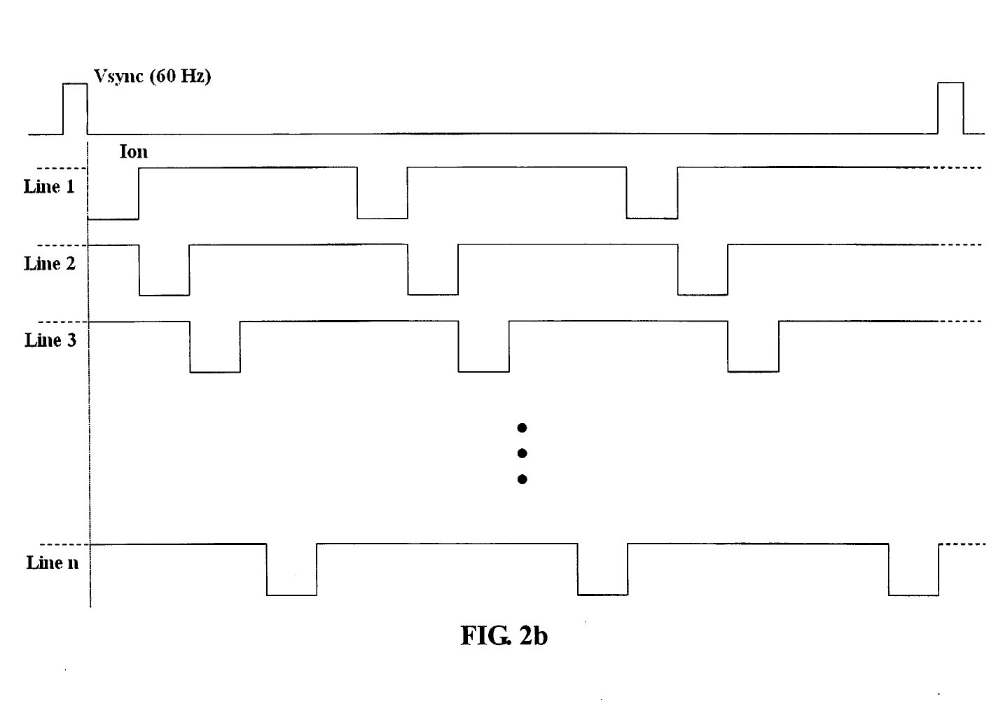

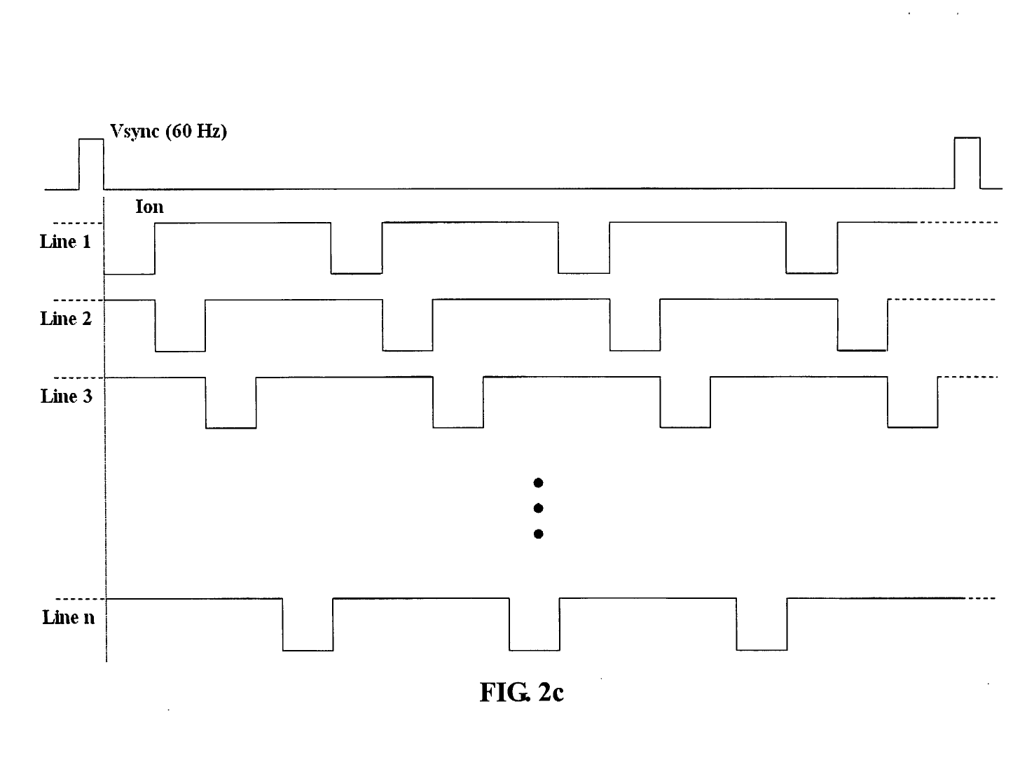

FIGS. 2a, 2b, and 2c are driver control signal waveform diagrams showing various variations of a first embodiment of the present invention. As illustrated, within a standard frame time ( 1/60 sec) defined by the vertical synchronous signal (Vsync) of the LCD device, the present embodiment applies driver control signals of identical waveform to the drivers of the backlight module. However, the phases of these driver control signals are delayed sequentially line by line from top to bottom (relative to the LCD device). As shown in FIGS. 2a, 2b, and 2c, in the very beginning of a frame time, the first line of LEDs is turned off while the rest of the LEDs are turned on (or remain to be on). Then, the second line of LEDs is turned off while the rest (including the originally off first line) of the LEDs are turned on (or remain to be on). Then, the third, fourth, . . . , lines of LEDs are turned off as described and finally the process repeats from the first line of LEDs again. In other words, within a frame time, the starting times of the first pulses (i.e., the first positive edges) of the driver control signals, indicated as Ion (i.e., the conducting current of the LEDs) are delayed line by line from top to bottom. As such, it appears that the n-line LEDs of the backlight module are sequentially turned off until the last line of LEDs is reached. The process then returns to the first line of LEDs again and the scenario repeats continuously. For the first embodiment, as the scanning speed of the LCD device can be a multiple integral of the frame rate (60 Hz), the frequency of the driver control signals can also be a multiple integral of the frame rate. In the variation of FIG. 2a, the frequency of the driver control signal is 120 Hz (two times the frame rate), and each line of LEDs within a frame time is therefore turned off twice. In the variation of FIG. 2b, the frequency of the driver control signal is 180 Hz (three times the frame rate), and each line of LEDs within a frame time is therefore turned off three times. Similarly, in the variation of FIG. 2c, the frequency of the driver control signal is 240 Hz (four times the frame rate), and each line of LEDs within a frame time is therefore turned off four times. In addition to frequency difference, each of the variations shown can have the duty cycle of each driver control signal adjusted (shown as the dashed line) so as to control the brightness of the backlight module. In other words, under the driver control signals of the same frequency, the backlight module would be brighter (or darker) if the duty cycle is larger (or smaller).

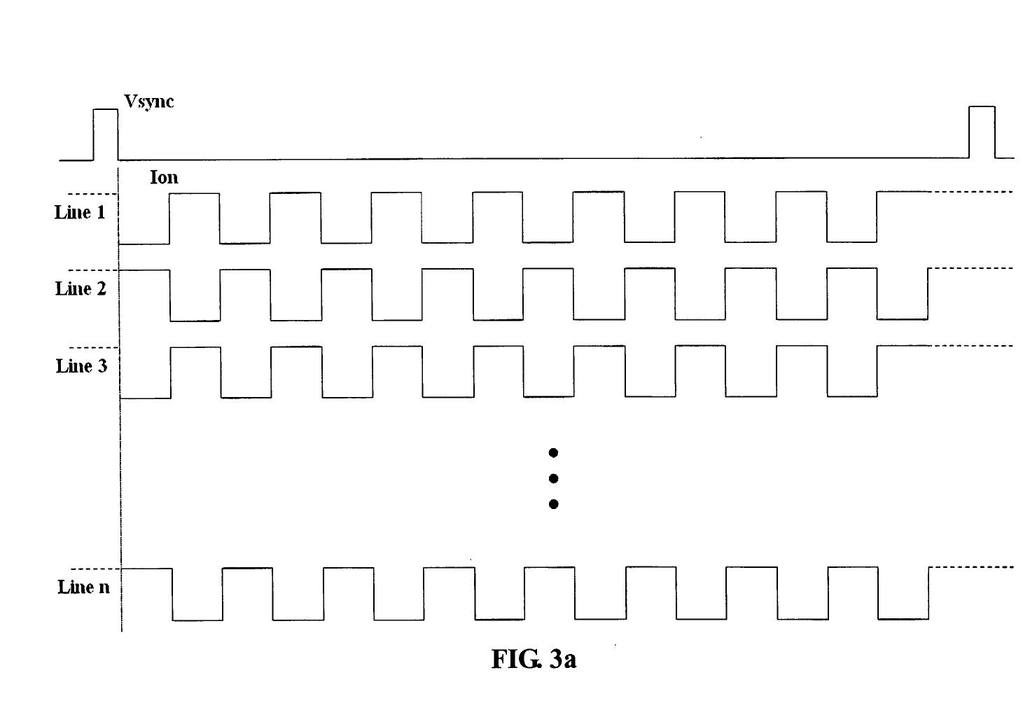

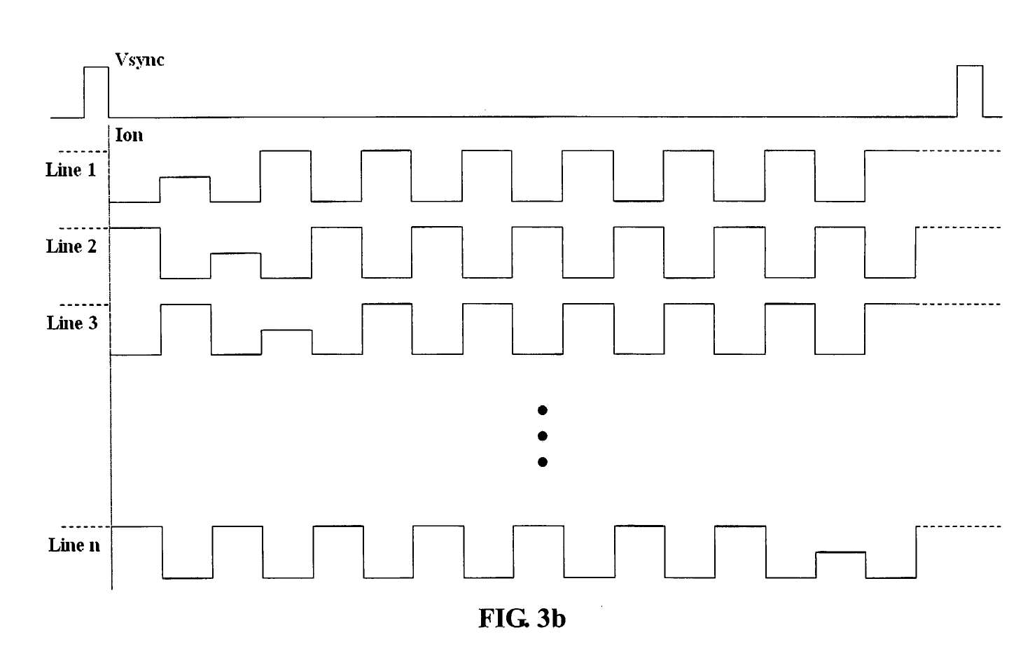

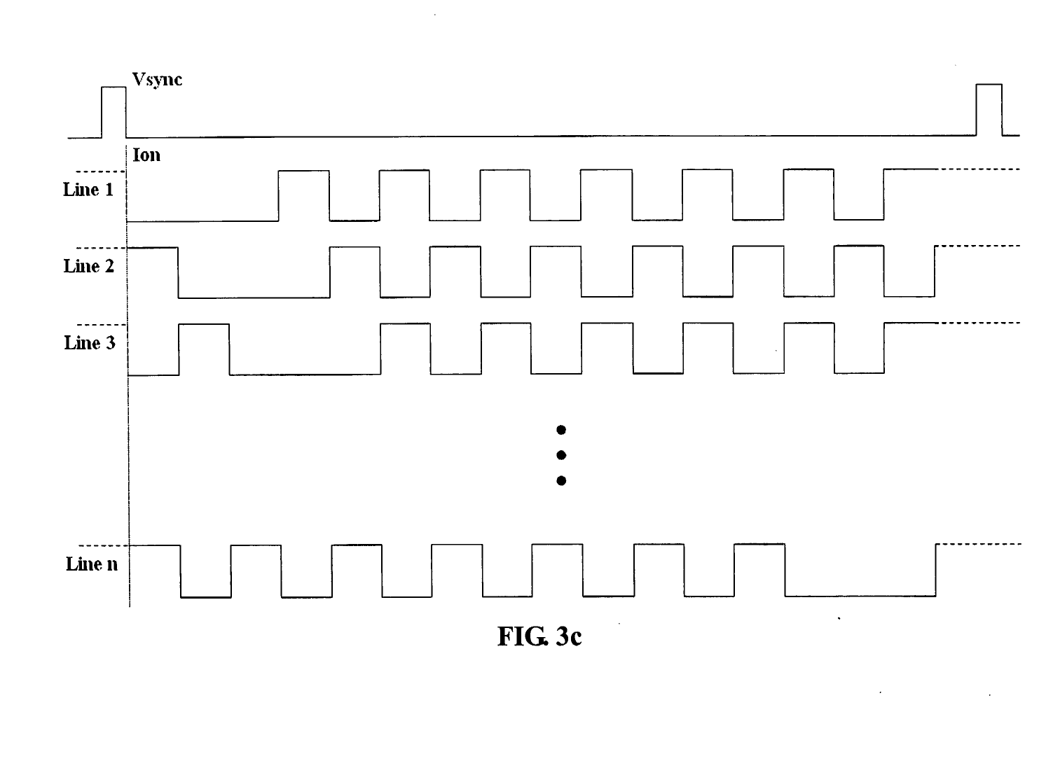

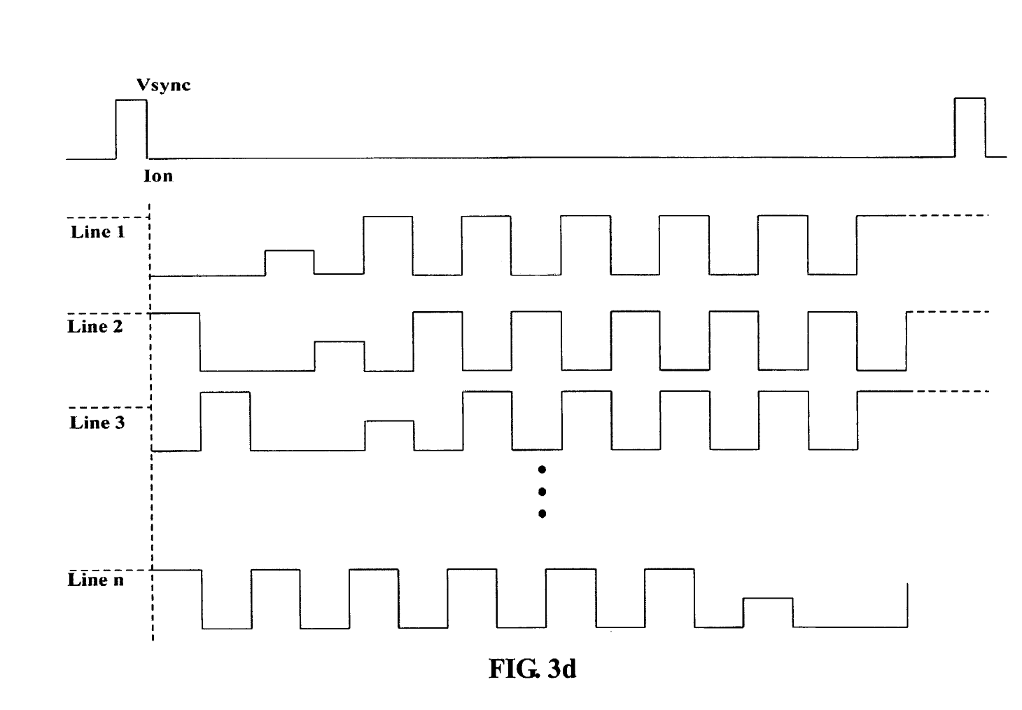

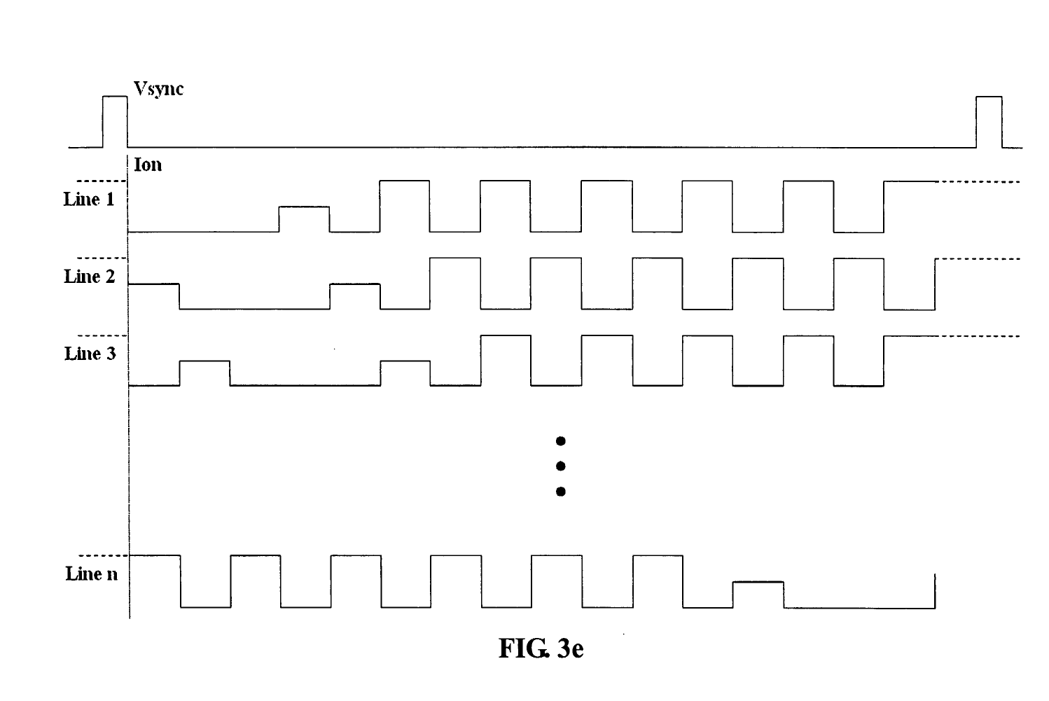

FIG. 3a is the driver control signal waveform diagram according to a second embodiment of the present invention. The present embodiment can also be considered as an extension of the previous embodiment when the duty cycle of the driver control signal is 50%. From another view point, the present embodiment applies the same driver control signals (A) and (B) to all odd-numbered and even-numbered lines of LEDs respectively. The driver control signals (A) and (B) have basically identical waveform and frequency except that one is delayed by ½ cycle (or, one is the inversion of the other). As such, the lighting of the odd-numbered lines of LEDs (and the darkening of the even-numbered lines of LEDs) is alternated with the lighting of the even-numbered lines of LEDs (and the lighting of the odd-numbered lines of LEDs) for one or more times within a frame time. FIGS. 3b, 3c, 3d, and 3e are a number of variations of the present embodiment which integrate the scanning idea of the first embodiment so as to: (1) conform to the top-down scanning of the LCD device; (2) reduce the impact of liquid crystal molecules' retardation property; and (3) lessen the leakage phenomenon of light from a lighted line to a neighboring darkened line.

When a scanline of the LCD device is enabled, due to the retarded response of the LCD device, the grey levels of the pixels on the enabled scanline gradually approach their targeted levels. During this transient period, the pulse of the driver control signal applied to the corresponding line of LEDs of the backlight module is reduced to a lower level so that the pixels' transient behavior is less obvious. Then, when the line of LEDs is turned on again later, the pulse level is returned to the normal level (i.e., full brightness). When the above principle is applied in accordance with the top-down scanning of the LCD device, the driver control signals will become what is shown in FIG. 3b. As such, during the alternated lighting of the odd-numbered and even-numbered lines, it appears that the lines of LEDs are dimmed line by line in accordance with the scanning of LCD device. More specifically, when the odd-numbered lines are turned on for the first time in a frame time, the first line of LEDs is darker than the other odd-numbered lines. Then, when the even-numbered lines are turned on for the first time in the frame time, the second line of the LEDs is darker than the other even-numbered lines. Again, when the odd-numbered lines are turned on for the second time, the third line of the LEDs is darker than the other odd-numbered lines, and so on.

The idea behind FIG. 3c is similar to that of FIG. 3b. Instead of applying a pulse of lower level, the present embodiment actually stops (or delays) to apply pulse to the line of LEDs behind the currently enabled scanline. As such, during the alternated lighting of the odd-numbered and even-numbered lines, it appears that the lines of LEDs are turned off line by line in accordance with the top-down scanning of LCD device. In other words, when the odd-numbered lines are turned on for the first time in a frame time, the first line of LEDs and all even-numbered lines are turned off. Then, when the even-numbered lines are turned on for the first time in the frame time, the second line of the LEDs and all odd-numbered lines are turned off. Again, when the odd-numbered lines are turned on for the second time, the third line of the LEDs and all even-numbered lines are turned off, and so on. From another view point, in accordance with the scanning of the LCD device, there are a number of darkened lines of LEDs (therefore, a dark belt) shifted from top to down and, when the last line of the LEDs is reached, the process repeats by starting all over again from the first line of LEDs. The advantage of the present embodiment is that none or only a limited amount of light from the lighted lines of LEDs adjacent to the “dark belt” is leaked under the currently enabled scanline. The transient behavior of the liquid crystal molecules is therefore less obvious.

The idea shown in FIG. 3d is the combination of the FIGS. 3b and 3c. As illustrated, during the alternated lighting of the odd-numbered and even-numbered lines, the lighting of the lines of LEDs are turned off or delayed line by line from top to bottom in accordance with the scanning of the LCD device. Then, when a line of LEDs is turned on again from the previous darkening, the pulse starts off with a lower level and then is raised back to the normal level subsequently.

FIG. 3e is a variation of FIG. 3d. As illustrated, during the alternated lighting of the odd-numbered and even-numbered lines, the lighting of the lines of LEDs are turned off line by line from top to bottom in accordance with the scanning of the LCD device. However, before a line of LEDs is turned off, the preceding pulse is reduced to a lower level first. Then, after a line of LEDs is to be turned on again, the succeeding pulse starts off with a lower level and then is raised back to the normal level subsequently. Both the approaches shown in FIGS. 3d and 3e can effectively reduce the amount of light from the lighted neighboring lines leaked to the darkened line.

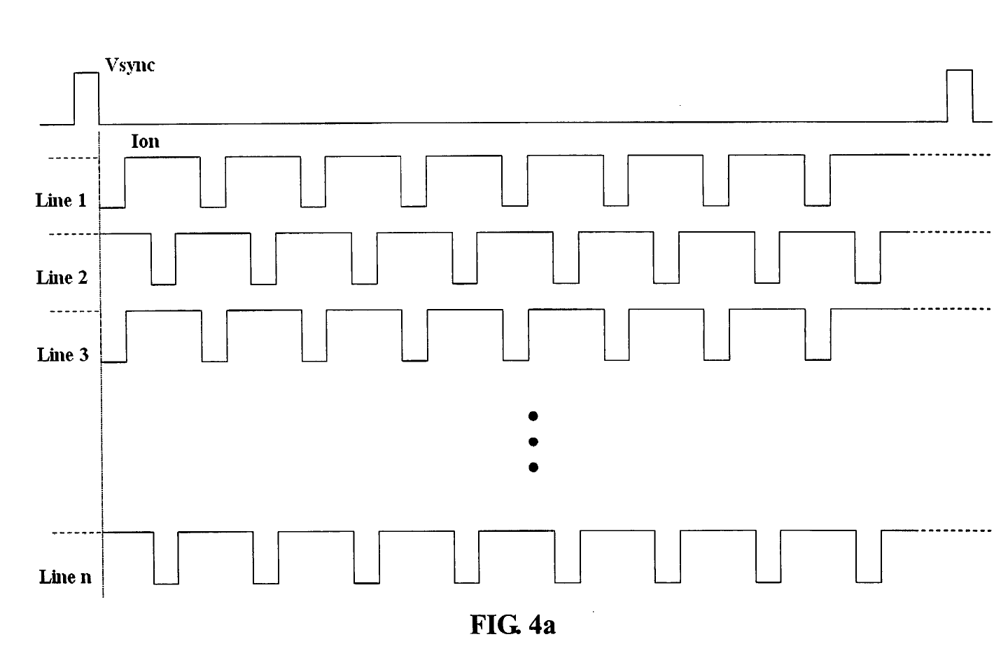

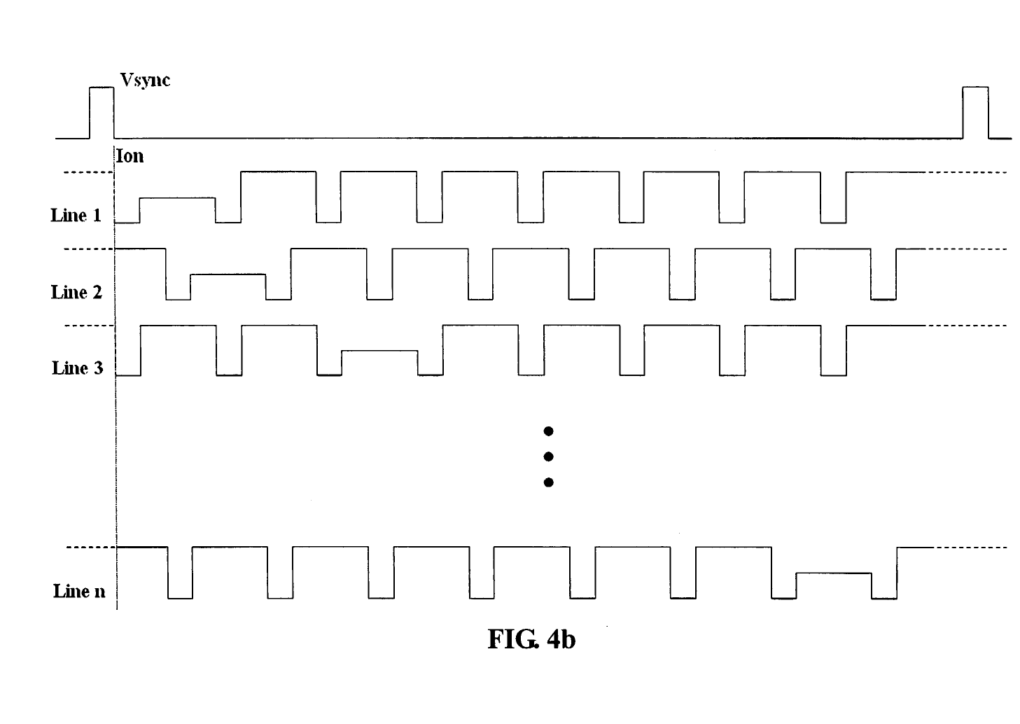

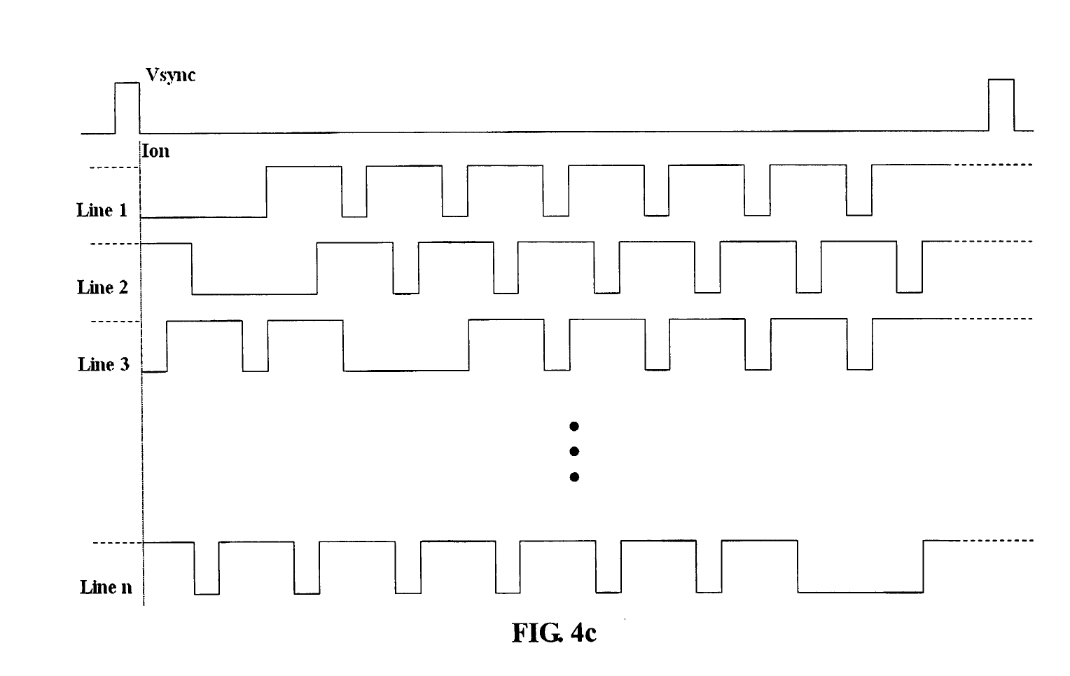

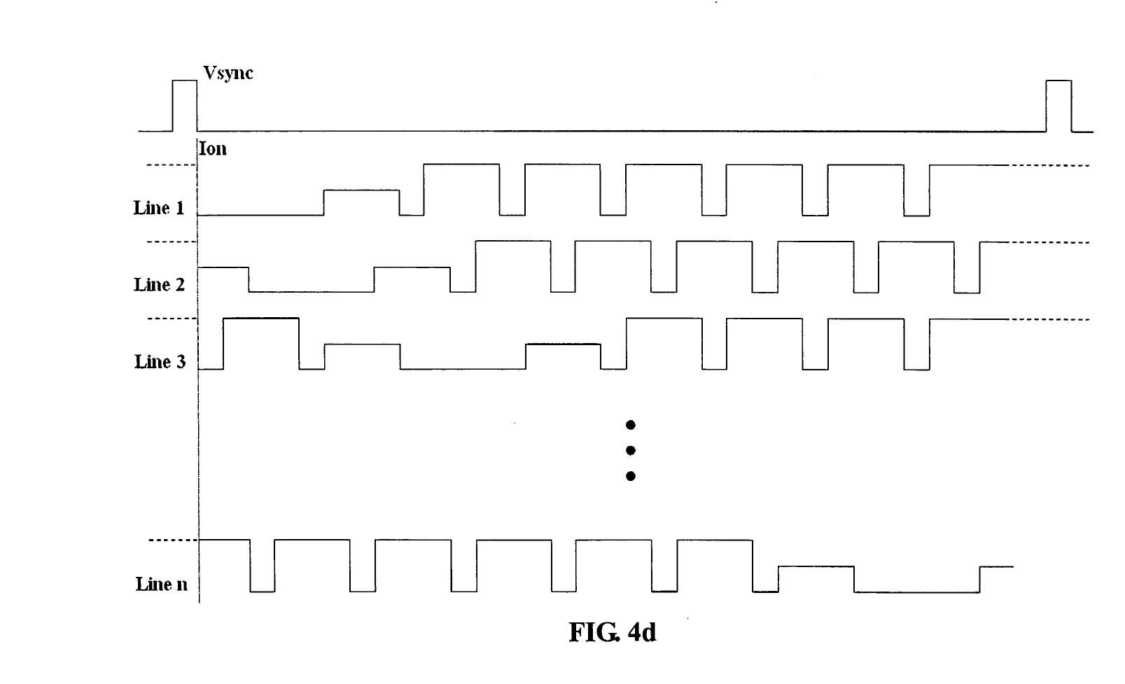

FIGS. 4a, 4b, 4c, and 4d are a number of variations according to a third embodiment of the present invention. They are very similar to those variations of the previous embodiment shown in FIGS. 3b, 3c, 3d, and 3e, respectively. The only difference lies in that, in FIGS. 4a, 4b, 4c, and 4d, driver control signals having asymmetric cycles are employed. As such, all odd-numbered or even-numbered lines are lighted for a period of time longer than when they are darkened; or all odd-numbered or even-numbered lines are darkened for a period of time longer than when they are lighted. Please note that, for this embodiment, it is possible to have all lines lighted or darkened at certain times. Please refer to the previous embodiment for details.

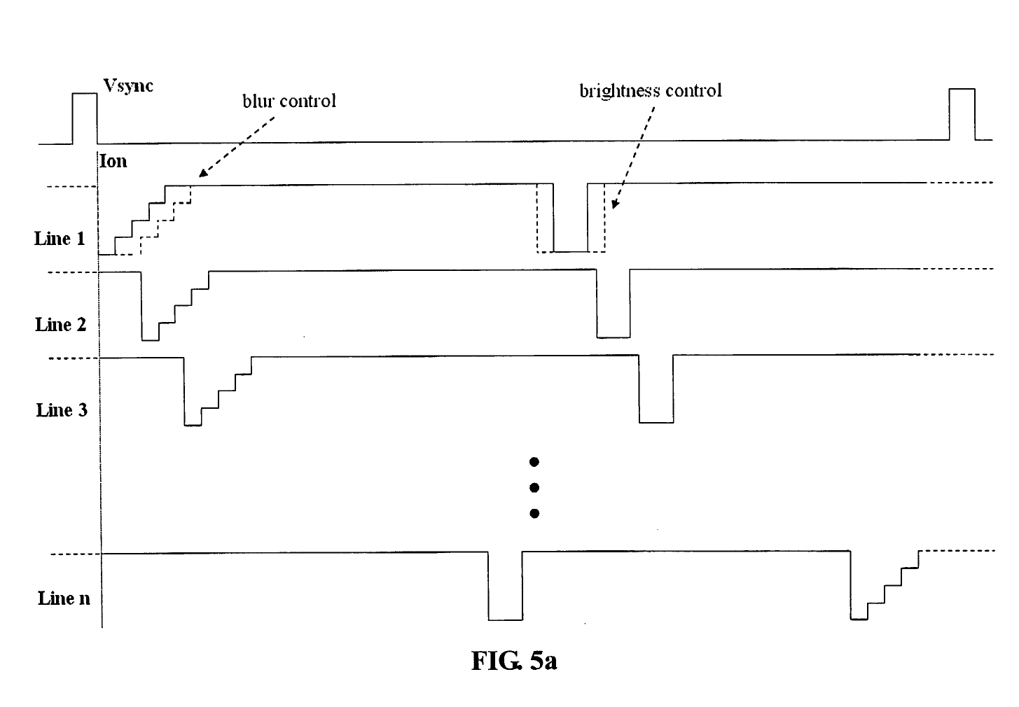

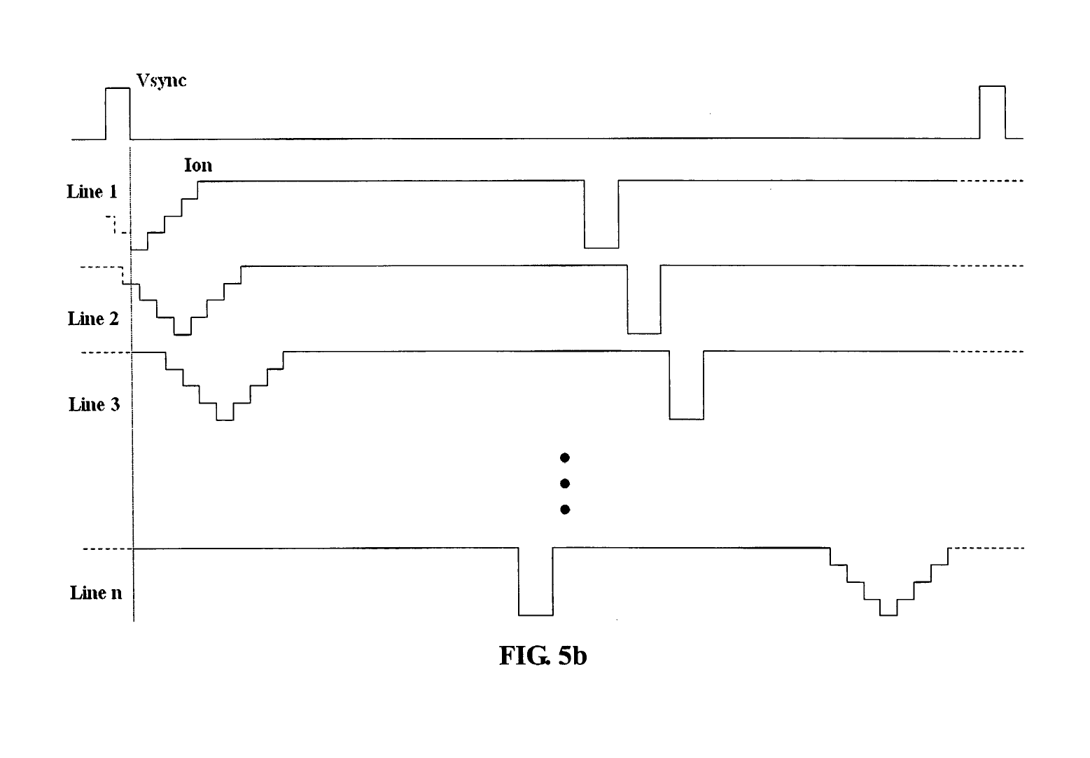

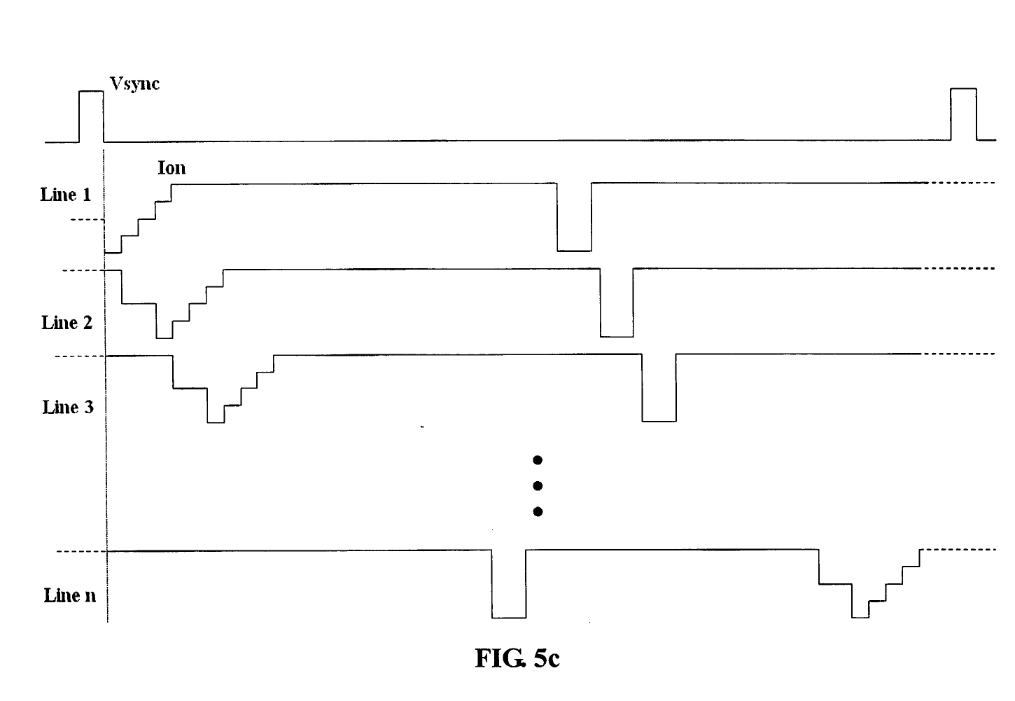

FIG. 5a is the driver control signal waveform diagram according to a fourth embodiment of the present invention. The present embodiment is actually an integration of the first embodiment (shown in FIGS. 2a, 2b, 2c) together with the gradual increase and decrease of pulse levels ideas of the previous second and third embodiments (shown in FIGS. 3a˜3e and FIGS. 4a˜4d). Similar to FIG. 2a, when the driver control signal is about to turn on a line of LEDs (i.e., the first positive edge) within a frame time, the driver control signal does not jump directly to the normal level, but is increased in a stepwise manner (i.e., a stepwise rising edge), so as to achieve blur control. The idea of FIG. 5a can be applied to the variations shown in FIGS. 2b and 2c as well where the frequency of the driver control signal is a multiple integral of the frame rate. Also similar to the first embodiment, the duty cycle of the driver control signal can be adjusted appropriately (shown as the dashed line) to control the brightness of the backlight module. FIGS. 5b and 5c are variations of FIG. 5a. As shown in FIG. 5b, when the driver control signal is about to turn off a line of LEDs (i.e., the negative edge before the first positive edge) within a frame time, the driver control signal does not drop directly to the lowest level, but is decreased in a stepwise manner (i.e., a stepwise decreasing edge), in addition to the stepwise increase of the driver control signal when a line of LEDs is turned on for the first time. Please note that the stepwise decrease and increase approaches can be implemented together as shown or separately in different embodiments. What is shown in FIG. 5c is that the step counts and step sizes for increasing and decreasing the driver control signal could be adjusted in accordance with the specific properties of the liquid crystal material of the LCD device.

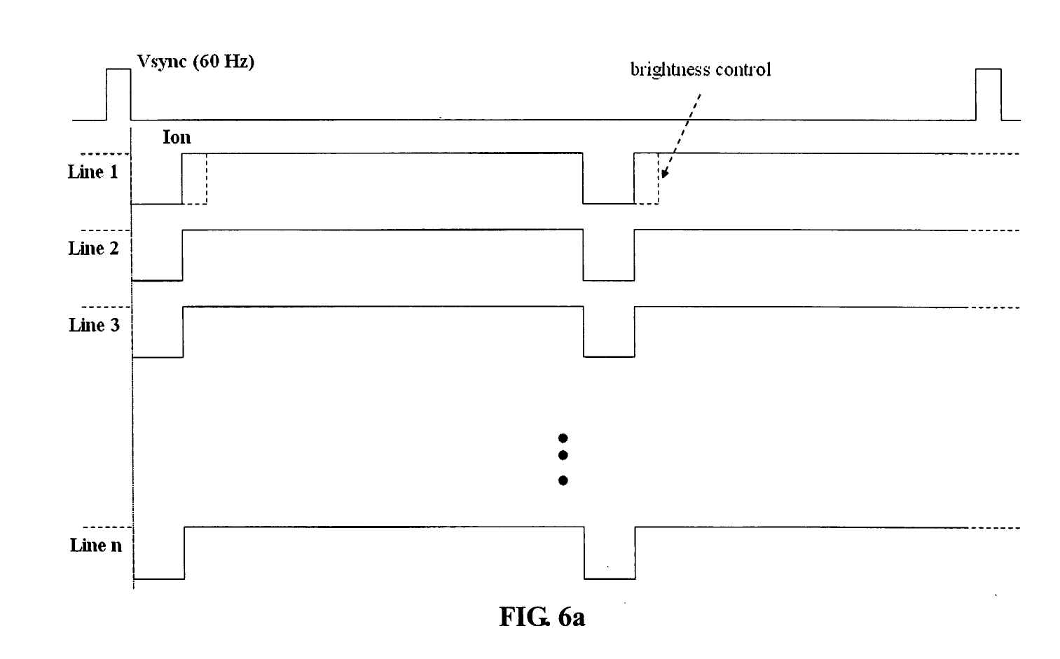

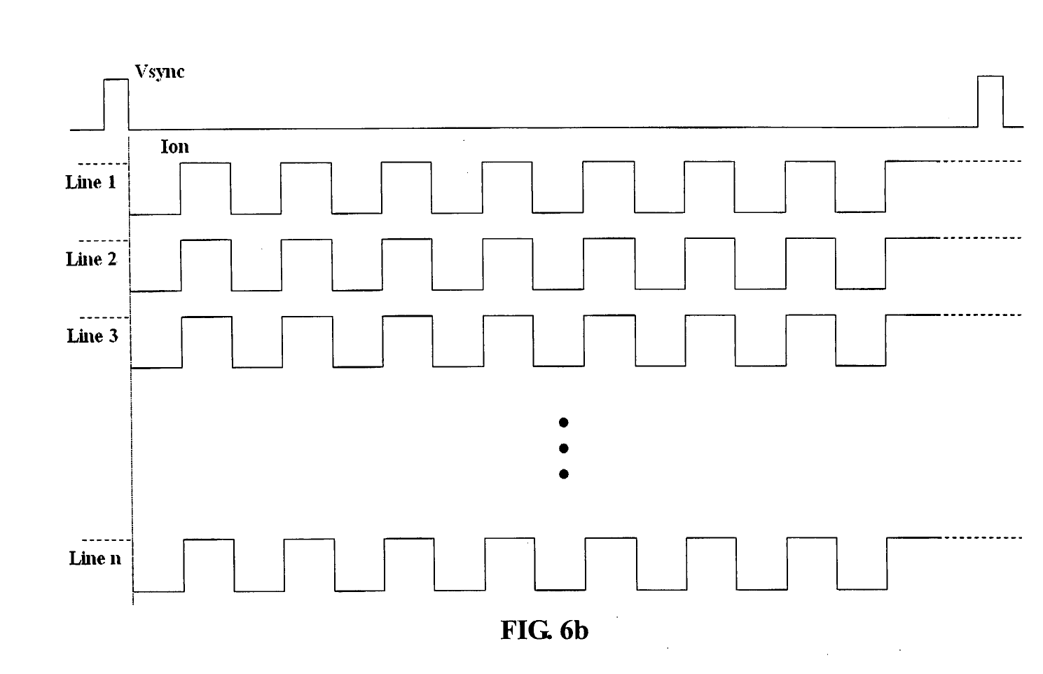

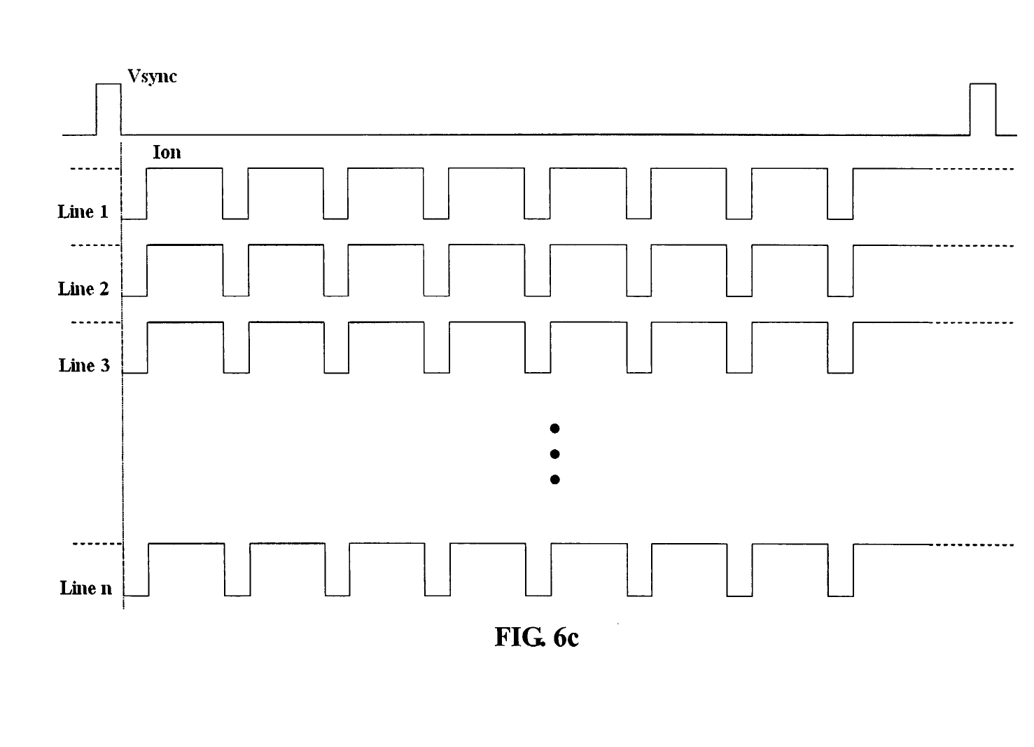

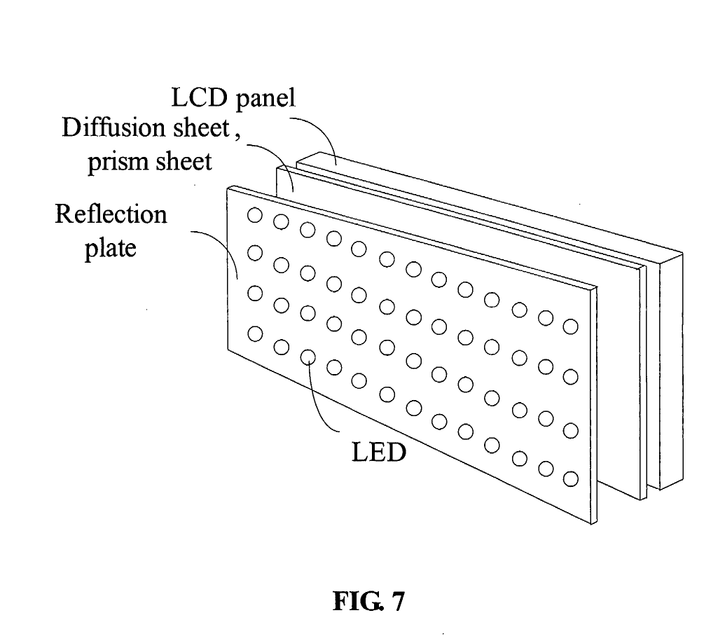

The previous embodiments all achieve a certain scanning effect for the LED-based, direct-lit backlight module. In other words, the lines of LEDs of the backlight module exhibit a line-by-line lighting (or darkening) behavior in a frame time in accordance with the scanning of the LCD device. FIG. 6a is the driver control signal waveform diagram according to a fifth embodiment of the present invention, which exhibits a different behavior. In the present embodiment, the lines of LEDs are driven simultaneously by a driver control signal whose frequency is a multiple integral of the frame rate (e.g., 120 Hz, 180 Hz, and 240 Hz). In other words, the backlight module is actually “flashed” instead of “scanned.” Similarly, the duty cycle of the driver control signal can be adjusted (shown by the dashed line) for brightness control. FIGS. 6b and 6c are two variation of FIG. 6a, where the signal cycles are symmetric (in FIG. 6b) or asymmetric (in FIG. 6c).

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A method for controlling a LED-based, direct-lit backlight module of a display device, said backlight module having a plurality of LEDs as light source arranged in a plurality of horizontal lines, said backlight module having a plurality of driver, each driving at least one of said lines of LEDs, said drivers being connected to a driver controller in an appropriate manner, said method, being implemented in said driver controller, comprising the steps of:
applying driver control signals having a train of pulses to said drivers respectively,
said driver control signals having a frequency being a multiple integral of the frame rate of said display device and a duty cycle at least 50%, the phase of said driver control signals being delayed sequentially line by line from top to bottom so that, within a frame time, said lines of LEDs being sequentially turned off from top to bottom at least once and, after the bottommost line of LEDs is turned off, the process repeats from the topmost line of LEDs.

2. The method according to claim 1, wherein said display device is one of a LCD device, a plasma display device, and an OLED display device.

3. The method according to claim 1, wherein said appropriate manner of connection is one of a series connection and a parallel connection.

4. The method according to claim 1, wherein said duty cycle is set appropriately so as to achieve a desired brightness of said backlight module.

5. The method according to claim 1, wherein, for each of said driver control signals, the pulse for turning on a line of LEDs for the first time in a frame time has a stepwise rising edge.

6. The method according to claim 1, wherein, for each of said driver control signals, the pulse before a line of LEDs is turned off for the first time in a frame time has a stepwise decreasing edge.

7. The method according to claim 1, wherein, for each of said driver control signals in a frame time, the pulse before a line of LEDs is turned off for the first time has a stepwise decreasing edge; and the pulse for turning on said line of LEDs for the first time has a stepwise rising edge.

8. A method for controlling a LED-based, direct-lit backlight module of a display device, said backlight module having a plurality of LEDs as light source arranged in a plurality of horizontal lines, said backlight module having a plurality of driver, each driving at least one of said lines of LEDs, said drivers being connected to a driver controller in an appropriate manner, said method, being implemented in said driver controller, comprising the following steps:
applying a driver control signal having a train of pulses to said drivers simultaneously, said driver control signal having a frequency being a multiple integral of the frame rate of said display device and a duty cycle at least 50% so that, within a frame time, said lines of LEDs being turned on and off simultaneously and periodically.

9. The method according to claim 8, wherein said display device is one of a LCD device, a plasma display device, and an OLED display device.

10. The method according to claim 8, wherein said appropriate manner of connection is one of a series connection and a parallel connection.

11. The method according to claim 8, wherein said duty cycle is set appropriately so as to achieve a desired brightness of said backlight module.

12. A method for controlling a LED-based, direct-lit backlight module of a display device, said backlight module having a plurality of LEDs as light source arranged in a plurality of horizontal lines, said backlight module having a plurality of driver, each driving at least one of said lines of LEDs, said drivers being connected to a driver controller in an appropriate manner, said method, being implemented in said driver controller, comprising the following steps:
applying a driver control signal having a train of pulses to said drivers of odd-numbered lines of LEDs simultaneously, said driver control signal having a frequency being a multiple integral of the frame rate of said display device and a duty cycle at least 50%; and concurrently applying another driver control signal which is the inversion of said driver control signal to said drivers of even-numbered lines of LEDs simultaneously.

13. The method according to claim 12, wherein said display device is one of a LCD device, a plasma display device, and an OLED display device.

14. The method according to claim 12, wherein said appropriate manner of connection is one of a series connection and a parallel connection.

15. The method according to claim 12, wherein, when a scanline of said display device is enabled, the pulse level of said driver control signal for a line of LEDs corresponding to said scanline is reduced to a lower level and then restored to the normal level in subsequent pulses.

16. The method according to claim 12, wherein, when a scanline of said display device is enabled, said driver control signal for a line of LEDs corresponding to said scanline stops to provide pulses.

17. The method according to claim 16, wherein, before said driver control signal for said corresponding line of LEDs stops to provide pulses, the preceding pulse is reduced to a lower level.

18. The method according to claim 16, wherein, when said driver control signal resumes providing pulses, the pulse level of said driver control signal for said corresponding line of LEDs is reduced to a lower level and then restored to the normal level in subsequent pulses.
